(19) United States
(12) Patent Application Publication
(10) Pub. No.: US 2025/0149222 A1
(43) Pub. Date: May 8, 2025

(54) IN-PLANE TWO-DIMENSIONAL TRANSLATIONAL OPTICAL ACTUATOR

(71) Applicant: Xi'an Zhisensor Technologies Co.,Ltd., Xi'an (CN)

(72) Inventors: Xiumin SONG, Xi'an (CN); Yan AN, Xi'an (CN); Yong REN, Xi'an (CN); Wei HE, Xi'an (CN); Xing GUO, Xi'an (CN)

(73) Assignee: Xi'an Zhisensor Technologies Co.,Ltd., Xi'an (CN)

(21) Appl. No.: 19/007,324

(22) Filed: Dec. 31, 2024

Related U.S. Application Data
(63) Continuation of application No. PCT/CN2023/104245, filed on Jun. 29, 2023.

(30) Foreign Application Priority Data
Oct. 12, 2022 (CN) 202211250920X
Oct. 12, 2022 (CN) 2022112516326

(51) Int. Cl. H01F 7/16; H01F 7/08

(52) U.S. Cl. CPC H01F 7/16; H01F 7/081

(57) ABSTRACT

The present disclosure relates to an in-plane two-dimensional translational optical actuator. The in-plane two-dimensional translational optical actuator includes a fixed plate, a translational plate, i elastic assemblies located between the fixed plate and the translational plate and with two ends connected to the fixed plate and the translational plate respectively, and j electromagnetic drive assemblies fixed between the fixed plate and the translational plate. Each elastic assembly is composed of elastic elements of the same or different quantities, and at least one elastic assembly in the i elastic assemblies has two or more elastic elements. The j electromagnetic drive assemblies are disposed in a plane in two different directions, and used to drive the translational plate to move relative to the fixed plate within a plane where the translational plate is located in two different directions, so as to achieve two-dimensional translation of the translational plate.

### CROSS-REFERENCE TO RELATED APPLICATIONS

The application claims priority to Chinese patent application No. 2022112516326 and 202211250920X, filed on Oct. 12, 2022, the entire contents of which are incorporated herein by reference.

### TECHNICAL FIELD

The present disclosure relates to a translational optical actuator, in particular to an in-plane two-dimensional translational optical actuator.

### BACKGROUND

An in-plane two-dimensional translational optical actuator can drive optical elements to perform an in-plane two-dimensional translational motion, which is suitable for optical application occasions that require the in-plane translational motion. The in-plane two-dimensional translational optical actuator can be used as an actuator in optical devices such as laser speckle dynamic eliminating devices and optical switches. Part of high-resonance-frequency and long-time working conditions pose strict requirements on the high-cycle fatigue life of an in-plane motion optical actuator, requiring the fatigue life of at least 10 billion cycles. In addition, to achieve miniaturization of an optical system, a space for arranging the in-plane motion optical actuator in an optical path is often limited, which requires the size of the actuator to be minimized as much as possible, as an excessive size will increase the volume of the entire optical system.

Invention patents (US 2016/0306183 A1) and (WO2010078662) disclose in-plane two-dimensional translational optical actuators with a magneto resistive drive structure and an electroactive polymer drive structure. The drive structures and elastic assemblies disposed around fixed optical element translational plates occupy a large in-plane space; and in addition, a drive force of the magneto resistive drive structure is relatively small, and the high-cycle fatigue life of the electroactive polymer drive structure also has a significant gap, making it difficult to apply to high-frequency working conditions for a long time.

### SUMMARY

### Technical Problem

The present disclosure aims to provide an in-plane two-dimensional translational optical actuator, which solves the problems that an existing in-plane two-dimensional translational optical actuator is large in size and the fatigue life of an elastomer can hardly meet the requirement of high-resonance-frequency and long-time working conditions for the life of the elastomer.

### Technical Solution

The technical solution of the present disclosure is as follows:
an in-plane two-dimensional translational optical actuator is characterized in that: it includes a fixed plate, a translational plate, i elastic assemblies located between the fixed plate and the translational plate and with two ends connected to the fixed plate and the translational plate respectively, and j electromagnetic drive assemblies fixed between the fixed plate and the translational plate, wherein i and j are both integers greater than or equal to 2;
the fixed plate is provided with a light transmission region;
the translational plate is provided with a light hole used to place an optical element;
positions of the light transmission region and the light hole need to ensure that a light beam is able to enter the optical element placed in the light hole;
each elastic assembly is composed of elastic elements of the same or different quantities, and at least one elastic assembly in the i elastic assemblies has two or more elastic elements; and
the j electromagnetic drive assemblies are disposed in a plane in two different directions, and used to drive the translational plate to move relative to the fixed plate within a plane where the translational plate is located in two different directions, so as to achieve two-dimensional translation of the translational plate.

Further, each electromagnetic drive assembly includes a drive coil and a magnet disposed at a drive end of the drive coil; and
the above drive coils are arranged on the fixed plate and the magnets are arranged on the translational plate; or, the drive coils are arranged on the translational plate and the magnets are arranged on the fixed plate.

Further, each electromagnetic drive assembly includes at least two magnets disposed at two drive ends of the drive coil respectively, and the two magnets have opposite polarities and have centers located on an axial central line of the drive coil.

Further, the elastic elements are made of conductive materials and used to provide follow-up components (such as the optical elements) located on the translational plate with an electric signaling pathway for transmission to the fixed plate, and meanwhile, a resonance frequency of the actuator may be adjusted by adjusting the quantity of the elastic elements.

Further, in order to enable the translational plate to translate in directions X and Y, the elastic assemblies have the same quantity of elastic elements, and the i elastic assemblies are symmetrical about a central axis of the fixed plate. In order to enable the translational plate to translate in directions other than the directions X and Y, the elastic assemblies have the different quantities of elastic elements, or are not symmetrical about the central axis of the fixed plate in position to form an asymmetric structure, and the translation directions of the translational plate deviate from the directions X and Y and may not be perpendicular. The translation directions of the translational actuator may be adjusted by adjusting the quantity of the elastic elements in each assembly and a distribution manner of the elastic elements.

Further, in order to ensure that translation displacements on two sides are the same when the translational plate translates in one direction, j-4, and every two electromagnetic drive assemblies form a set of drive units, two sets of drive units in total; and two electromagnetic drive assemblies in the same set of drive units are used to drive the translational plate to move relative to the fixed plate within the plane where the translational plate is located in the same direction.

Further, the above in-plane two-dimensional translational optical actuator further includes a drive coil supporting seat and a magnet supporting seat, wherein the drive coils are fixed on the drive coil supporting seat, and the magnets are fixed on the magnet supporting seat.

The drive coil supporting seat is fixed on the fixed plate and the magnet supporting seat is fixed on the translational plate, or, the drive coil supporting seat is fixed on the translational plate and the magnet supporting seat is fixed on the fixed plate.

Further, the drive coil supporting seat includes two sets of supporting arms arranged in parallel, one end of each supporting arm is fixed on the fixed plate or the translational plate, the other end of each supporting arm is provided with a clamping groove, and the two drive ends of each drive coil are clamped in the clamping grooves to be fixed; and the axial central lines of the drive coils of the two electromagnetic drive assemblies in one set of drive units are parallel to the direction X, and the axial central lines of the drive coils of the two electromagnetic drive assemblies in another set of drive units are parallel to the direction Y.

Further, the drive coil supporting seat includes a supporting frame and a coil positioning structure fixed on the supporting frame, one end of each coil positioning structure is provided with a clamping groove, and the two ends of each drive coil are clamped in the clamping grooves to be fixed; and the axial central lines of the drive coils of the two electromagnetic drive assemblies in one set of drive units are parallel to the direction X, and the axial central lines of the drive coils of the two electromagnetic drive assemblies in another set of drive units are parallel to the direction Y.

Further, a light hole may be formed in the light transmission region of the fixed plate, so that a light beam directly passes through the light hole conveniently and enters an optical element placed in the light hole. In order to provide a pathway for a drive electric signal of a device and an electric signal of the optical element, a PCB is adopted as the fixed plate, and an outlet terminal of each drive coil may be welded to a corresponding pad of the fixed plate.

Further, in order to reduce the mass of the translational plate to achieve a larger displacement under the same drive force, the translational plate is hollowed out except a functional region. At the same time, a PCB may also be adopted as the translational plate.

Further, the fixed plate and the translational plate are each a rectangular PCB and are parallel to each other, and a center of the fixed plate and a center of the translational plate are located on a same straight line;
the light transmission region of the fixed plate is located at the center of the fixed plate, and the light hole of the translational plate is located at the center of the translational plate; and
i=4, the 4 elastic assemblies are parallel to each other, one ends of the elastic assemblies are fixed to four corners of the fixed plate respectively, and the other ends are fixed to four corners of the translational plate respectively; and the electromagnetic drive assemblies are located between every two adjacent elastic assemblies.

Further, each drive coil is formed by winding a wire on a magnetic core, sections of the magnets are rectangular, and the problem that, during two-dimensional motions, relative positions of the magnetic core and the magnets of its drive structure change in one direction due to movement in the other direction, leading to the interference of a drive force in that direction is alleviated.

### Beneficial Effects

The present disclosure has the beneficial effects:

1. The in-plane two-dimensional translational optical actuator of the present disclosure adopts the plurality of elastic elements as the elastic assemblies, which ensures a long high-cycle fatigue life of the elastic assemblies while guaranteeing the resonance frequency. Meanwhile, the electromagnetic drive assemblies are placed between the fixed plate and the translational plate, an in-plane space required to be occupied by the actuator is reduced, and two-dimensional translation is achieved by disposing the electromagnetic drive assemblies in the two directions.

2. In the present disclosure, the magnets with opposite polarities are disposed on two sides of the drive coils to form the electromagnetic drive assemblies with significantly reduced volumes, the two magnets with opposite polarities produce pushing and pulling forces under the action of the drive coils, the drive force is greatly increased, and thus large-displacement translation of the actuator is easy to achieve. Besides, the centers of the two magnets are located on the axial central lines of the drive coils, which ensures the reduction of mutual interference between the drive forces of a driver in two directions.

3. The present disclosure adopts the elastic elements made of the conductive material to provide an elastic recovery force for the actuator, and at the same time, the electric signaling pathway for transmission to the fixed plate may be provided for the follow-up components on the translational plate, which solves the problem of establishing an electric signaling pathway for movable components.

4. In the present disclosure, the resonance frequency of the actuator may be adjusted by adjusting the quantity of the elastic elements, and the translation direction of the actuator may be adjusted by adjusting the quantity and a distribution manner of the elastic elements, such that the actuator adapts to various application scenarios flexibly.

5. In the present disclosure, two-dimensional translation is achieved by disposing the electromagnetic drive assemblies on double sides in two directions, the disposing form of double-side electromagnetic structures in a single direction uniformizes motion amplitudes on the two sides of the translational plate, meanwhile, the drive force is further increased, and large-displacement translation is easier to achieve.

6. The fixed plate and the translational plate in the in-plane two-dimensional translational optical actuator of the present disclosure may both adopt the PCBs, which provides a pathway for drive electric signals of devices and electric signals of the optical elements.

### BRIEF DESCRIPTION OF DRAWINGS

FIG. 1 is a schematic structural diagram of an in-plane two-dimensional translational optical actuator in Embodiment 1 of the present disclosure.

FIG. 2 is a schematic structural diagram of a fixed plate in an in-plane two-dimensional translational optical actuator in Embodiment 1 of the present disclosure.

FIG. 3 is a schematic structural diagram of a translational plate in an in-plane two-dimensional translational optical actuator in Embodiment 1 of the present disclosure.

FIG. 4 is a schematic structural diagram of a fixed plate, a translational plate and elastic assemblies in an in-plane two-dimensional translational optical actuator in Embodiment 1 of the present disclosure.

FIGS. 5A and B is a schematic diagram of adjusting a translation direction of a translational plate by adjusting the quantity of elastic elements and a distribution manner of the elastic elements in an in-plane two-dimensional translational optical actuator in Embodiment 1 of the present disclosure, wherein (a) is a schematic diagram of a local structure of an in-plane two-dimensional translational optical actuator after adjustment of the quantity of the elastic elements, and (b) is a schematic diagram of the translation direction of the translational plate.

FIG. 6 is a schematic diagram of a local structure of an in-plane two-dimensional translational optical actuator in Embodiment 1 of the present disclosure.

FIG. 7A, B, C and Dis a schematic structural diagram of electromagnetic drive assemblies in an in-plane two-dimensional translational optical actuator in Embodiment 1 of the present disclosure, wherein (a), (b), (c) and (d) represent different distribution manners of magnetic poles of magnets.

FIG. 8 is a schematic structural diagram of a single electromagnetic drive assembly in an in-plane two-dimensional translational optical actuator in Embodiment 1 of the present disclosure.

FIGS. 9A and B is a schematic diagram of connections of all drive coils in an in-plane two-dimensional translational optical actuator in Embodiment 1 of the present disclosure, wherein in Fig. (a), the drive coils are connected in series, and in Fig. (b), the drive coils located on opposite sides are connected in parallel.

FIG. 10 is a schematic structural diagram of a drive coil supporting seat in Embodiment 2 of the present disclosure.

FIG. 11 is a schematic diagram of mounting of drive coils on a coil supporting seat in Embodiment 2 of the present disclosure.

FIG. 12 is a schematic structural diagram of an in-plane two-dimensional translational optical actuator in Embodiment 3 of the present disclosure.

### Reference Numerals in the Figures

1, fixed plate; 1.2, first light hole; 2, drive coil supporting seat; 3, elastic assembly; 4, drive coil; 5, magnet supporting seat; 6, magnet; 7, translational plate; 7.2, second light hole; 8.3, positioning hole; 8.2, positioning pin hole;

1.1-1, 1.1-2, 1.1-3, 1.1-4, 7.1-1, 7.1-2, 7.1-3 and 7.1-4 are all connecting holes;

2-5.1, 2-5.2, 2-5.3 and 2-5.4 are all coil positioning structures;

5.1-1, 5.1-2, 5.2-1, 5.2-2, 5.3-1, 5.3-2, 5.4-1 and 5.4-2 are all magnets;

6.1-1, 6.1-2, 6.2-1, 6.2-2, 6.3-1, 6.3-2, 6.4-1 and 6.4-2 are all magnet supporting seats; and

4.1, 4.2, 4.3 and 4.4 are all drive coils.

### DETAILED DESCRIPTION OF THE EMBODIMENTS

The present disclosure is further described below in conjunction with the accompanying drawings and specific embodiments.

### Embodiment 1

An in-plane two-dimensional translational optical actuator of this embodiment is mainly composed of a fixed plate 1, a translational plate 7, at least two elastic assemblies 3 and at least two drive assemblies. In order to ensure a long high-cycle fatigue life of the elastic assemblies, a plurality of elastic elements are adopted as the elastic assemblies 3. Two ends of each of the plurality of elastic elements are fixed on the fixed plate 1 and the translational plate 7 respectively. The drive assemblies are fixed between the fixed plate 1 and the translational plate 7, and compared to a peripherally disposed structure, the volume of the actuator is greatly reduced. Each drive assembly includes a drive coil 4 and a magnet 6, and to fix the drive coil 4 and the magnet 6, a drive coil supporting seat 2 and a magnet supporting seat 5 may further be arranged.

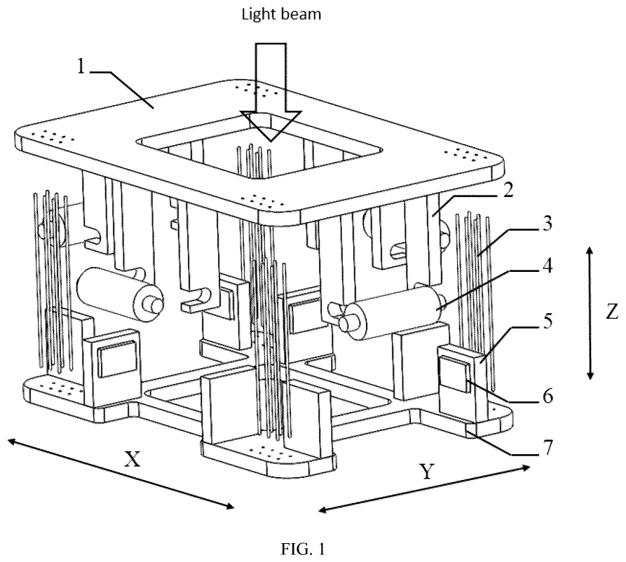

As shown in FIG. 1, the drive coil supporting seat 2 includes two sets of supporting arms arranged in parallel, one end of each of the supporting arms is fixed on the fixed plate, the other end is provided with a clamping groove, and two ends of each drive coil 4 are clamped in the clamping grooves to be fixed. Upper end parts of the elastic elements of the elastic assemblies 3 are connected with the fixed plate 1, and lower end parts are connected with the translational plate 7. The magnet supporting seat 5 is connected with the translational plate 7 to provide supporting for the magnets 6, and the magnets 6 are placed on corresponding supporting structures on the magnet supporting seat 5 and disposed in alignment with the drive coils 4.

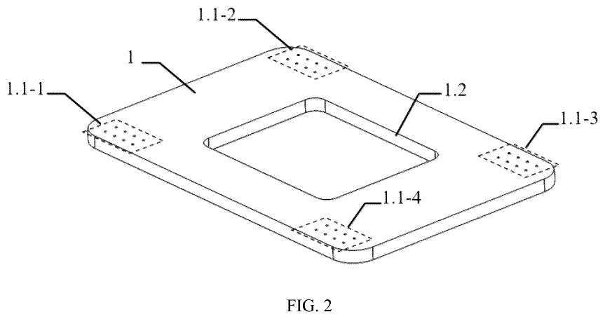

As shown in FIG. 2, this embodiment adopts a rectangular fixed plate, and connecting holes 1.1-1, 1.1-2, 1.1-3 and 1.1-4 are formed in four corners of the fixed plate and used to be connected with upper ends of the elastic elements in the four elastic assemblies 3 so as to fix the upper end parts of the elastic assemblies 3. A first light hole 1.2 is further formed in the center of the fixed plate to avoid shielding of a light beam by the fixed plate 1. In other embodiments, the first light hole may not be formed, and a region corresponding to the first light hole of the fixed plate is arranged as a light transmission material. The fixed plate 1 may be a PCB to provide a pathway for a drive electric signal of a device and an electric signal of an optical element, and an outlet terminal of each drive coil 4 may be welded to a corresponding pad of the fixed plate 1, which also facilitates the manufacture of tiny electric connecting holes for tiny elastic elements.

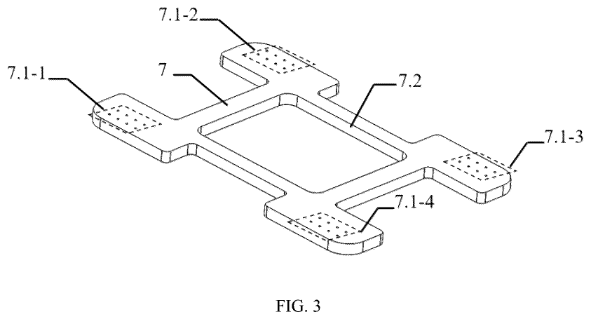

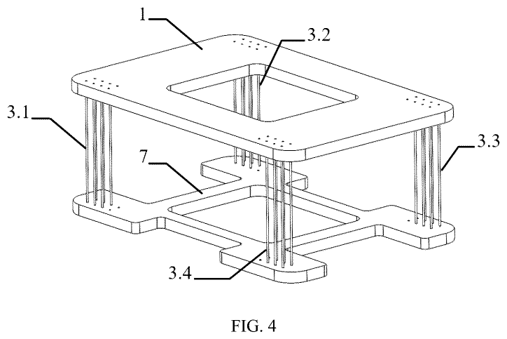

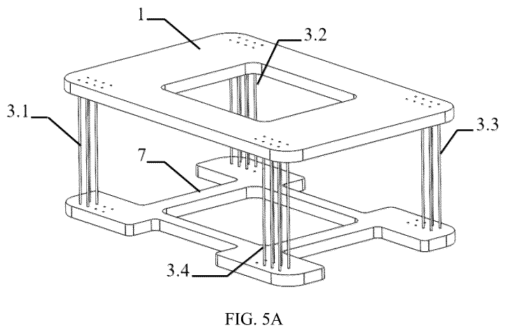

As shown in FIG. 3, the translational plate 7 in this embodiment may also be rectangular, and connecting holes 7.1-1, 7.1-2, 7.1-3 and 7.1-4 are also formed in four corners of the rectangular translational plate and used to be connected with lower ends of the elastic elements in the four elastic assemblies 3 so as to fix the lower end parts of the elastic assemblies 3. The connecting holes 7.1-1, 7.1-2, 7.1-3 and 7.1-4 are in one-to-one correspondence with the connecting holes 1.1-1, 1.1-2, 1.1-3 and 1.1-4 in the fixed plate 1. The translational plate 7 is further provided with a second light hole 7.2 for placing an optical element. The forming positions and sizes of the second light hole 7.2 and the first light hole 1.2 need to ensure that a light beam can pass through the first light hole 1.2 to enter the optical element placed in the second light hole 7.2. The translational plate 7 is hollowed-out except a functional region, so the mass of the translational plate 7 is reduced. The translational plate 7 may be a PCB to provide a pathway for a drive electric signal of a device and an electric signal of the optical element, which facilitates the manufacture of tiny electric connecting holes for tiny elastic elements.

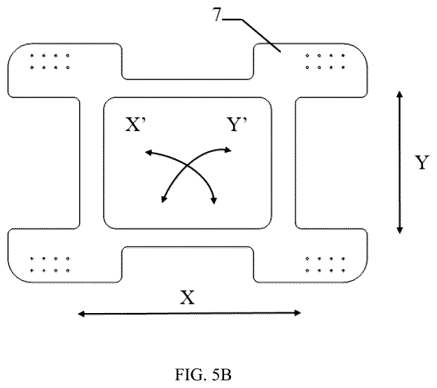

As shown in FIG. 4, this embodiment includes 4 elastic assemblies 3 which are defined as an elastic assembly 3.1, an elastic assembly 3.2, an elastic assembly 3.3 and an elastic assembly 3.4 respectively. Each elastic assembly 3 includes a plurality of elastic elements, the upper end parts of the elastic elements are connected with the connecting holes 1.1-1, 1.1-2, 1.1-3 and 1.1-4 corresponding to the fixed plate 1, and the lower end parts are connected with the connecting holes 7.1-1, 7.1-2, 7.1-3 and 7.1-4 corresponding to the translational plate 7, so that an elastic recovery force is provided for the actuator. In this embodiment, the elastic elements constituting the elastic assemblies 3 are made of conductive materials, such as piano wires, stainless steel wires, beryllium copper wires, titanium wires and other high-strength metal wires, so as to provide follow-up components on the translational plate 7 with an electric signaling pathway for transmission to the fixed plate 1. At least one of the 4 elastic assemblies 3 has two or more elastic elements, the plurality of elastic elements equally divide stress produced by translation, under the condition of the same free length and translational displacement of the elastic elements, stress borne by a single elastic element is greatly reduced, a high-cycle fatigue life of a device is effectively prolonged, and meanwhile, the quantity of electric signaling pathways for transmission to the fixed plate 1 of motion components is increased.

In FIG. 4, the elastic assemblies 3 have the same quantity of elastic elements and are symmetrical about a center of the entire in-plane two-dimensional translational optical actuator in position, and translation directions of the translational plate 7 are perpendicular directions X and Y. By adjusting the quantity of the elastic elements, rigidities of the elastic assemblies 3 and a resonance frequency of the actuator may be adjusted.

By adjusting the quantity of the elastic elements of the elastic assemblies or distribution positions of the elastic assemblies, the translation directions of the translational plate may be adjusted. As shown in FIG. 5, the elastic assemblies 3 have the different quantities of elastic elements, or are not symmetrical about the center of the entire translational plate in position to form an asymmetric structure, and the translation directions of the translational plate deviate from the directions X and Y and may not be perpendicular. In FIG. 5, the quantities and positions of the elastic element 3.1 and the elastic element 3.3 are adjusted to adjust the translation directions of the actuator to directions X′ and Y′.

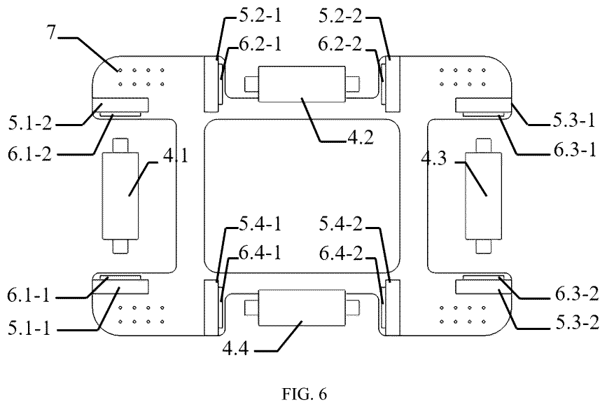

As shown in FIG. 6, each drive coil 4 is formed by winding a wire on a magnetic core, and magnets 5.1-1, 5.1-2, 5.2-1, 5.2-2, 5.3-1, 5.3-2, 5.4-1 and 5.4-2 are placed on supporting structures of magnet supporting seats 6.1-1, 6.1-2, 6.2-1, 6.2-2, 6.3-1, 6.3-2, 6.4-1 and 6.4-2 respectively and are aligned to centers of corresponding drive coils 4.1, 4.2, 4.3 and 4.4 respectively so as to form 4 sets of electromagnetic drive structures which are symmetrical on double sides.

Sections of the magnetic cores and the magnets 6 are square or rectangular, preferably, the sections of the magnets 6 are rectangular, and the problem that, during two-dimensional motions, relative positions of the magnetic cores and the magnets of its drive structures change in one direction due to movement in the other direction, leading to the interference of a drive force in that direction is alleviated.

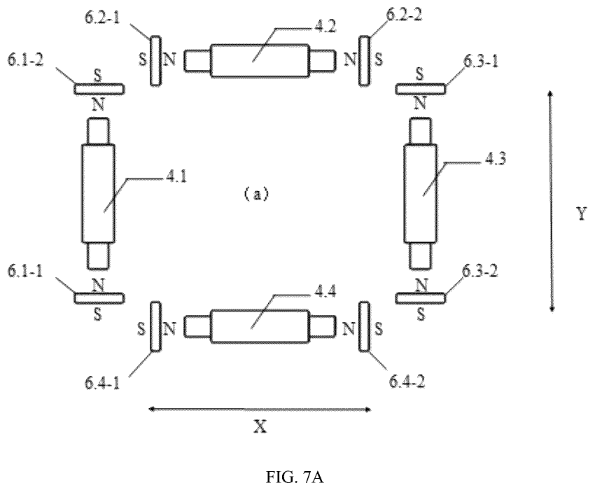

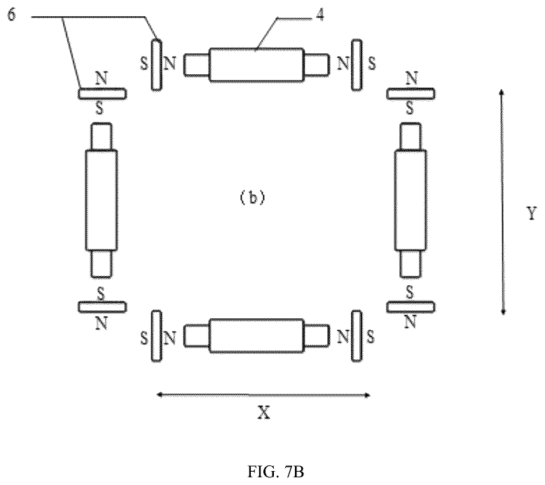

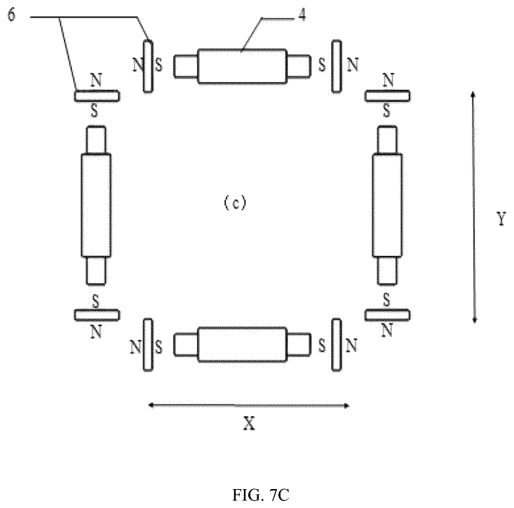

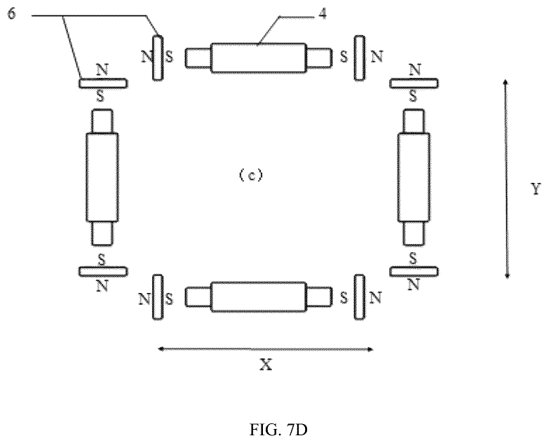

As shown in FIG. 7, the magnets located on the same side are disposed with same-polarity poles being opposite, one side of an energized coil forms a repulsive force with the magnets, the other side forms an attractive force with an energized coil, and pushing and pulling forces push the magnets to move in an axial direction of the drive coils. As shown in Fig. (a), an N pole of the magnet 6.1-1 is opposite to an N pole of the magnet 6.1-2, an N pole of the magnet 6.2-1 is opposite to an N pole of the magnet 6.2-2, an N pole of the magnet 6.3-1 is opposite to an N pole of the magnet 6.3-2, an N pole of the magnet 6.4-1 is opposite to an N pole of the magnet 6.4-2. Magnetic properties of the opposite magnetic poles may be switched, and Figs. (b)-(d) are different magnet arrangement forms.

The opposite magnetic poles of the magnets corresponding to the coils on opposite sides may be the same or different, as long as pushing and pulling forces formed between the coils on opposite sides and the magnets at the same time are identical in direction. Two magnets located at the same corner are opposite with different polarities at the 90° corner and attract each other by the different polarities, which facilitates mounting the magnets on the magnet supporting seats, as shown in FIG. 7 (b) and FIG. 7 (d). Optionally, the two magnets located at the same corner may be replaced by one magnet with magnetic pole directions being 90°.

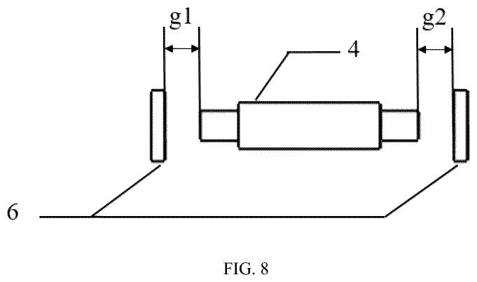

Gaps between each drive coil 4 and two corresponding magnets 6 are the same, namely g1=g2, and are greater than a motion amplitude in this direction, as shown in FIG. 8. Optionally, the gaps between each drive coil 4 and two corresponding magnets 6 are different, namely g1≠g2, and thus the translational plate has an initial displacement, which is used to adjust an initial position of the optical element.

The in-plane two-dimensional translational actuator in this embodiment has the operation principle that: drive signals are applied to the two drive coils 4.1 and 4.3 on opposite sides, and pushing and pulling forces consistent in direction formed between the drive coils and the corresponding magnets 6 push the magnet supporting seat 5 to drive the translational plate 7 to translate in the direction Y. Drive signals are applied to the two drive coils 4.2 and 4.4 on opposite sides, and pushing and pulling forces consistent in direction formed between the drive coils and the corresponding magnets 6 push the magnet supporting seat 5 to drive the translational plate 7 to translate in the direction X. Therefore, the translational plate 7 is driven to drive the optical element to translate in the two perpendicular directions X and Y. By adjusting the quantity and positions of the elastic elements of the elastic assemblies 3, the resonance frequency and translation direction of the actuator are adjusted.

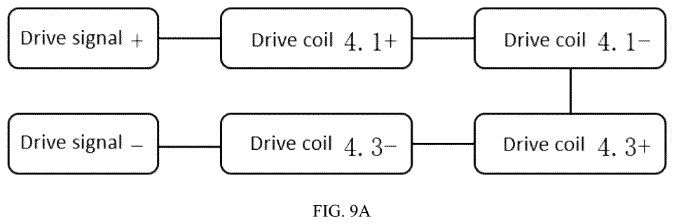

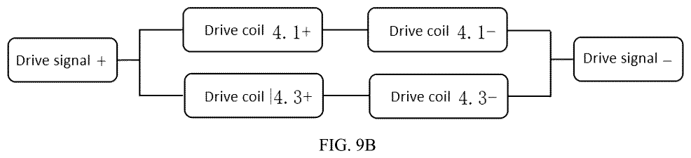

As shown in FIG. 9, the two drive coils 4.1 and 4.3 located on the opposite sides may be connected in series or in parallel, so drive forces consistent in direction are formed on the two sides. Likewise, the drive coils 4.2 and 4.4 may be connected in series or in parallel.

### Embodiment 2

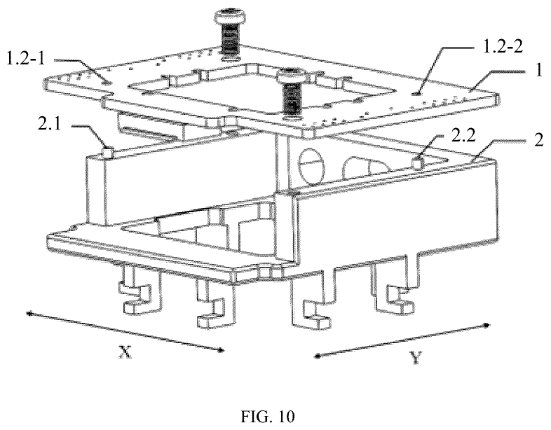

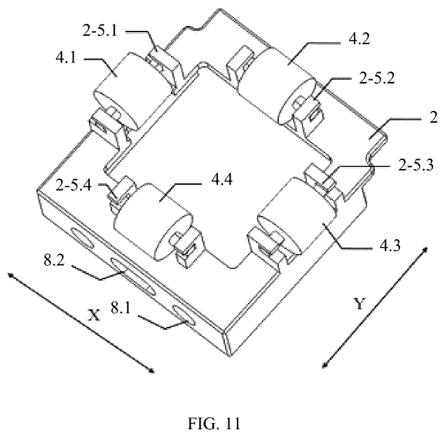

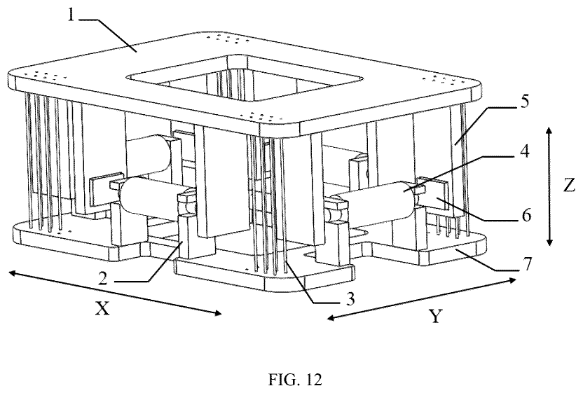

As shown in FIG. 10 and FIG. 11, a drive coil supporting seat 2 includes a supporting frame as well as a first coil positioning structure 2-5.1, a second coil positioning structure 2-5.2, a third coil positioning structure 2-5.3 and a fourth coil positioning structure 2-5.4 fixed on the supporting frame. A clamping groove is formed in one end of each coil positioning structure, two ends of each of a first drive coil 4.1, a second drive coil 4.2, a third drive coil 4.3 and a fourth drive coil 4.4 are clamped in the clamping grooves of the corresponding coil positioning structures respectively to be fixed, and outlet terminals of the drive coils 4 are welded to corresponding pads of a fixed plate 1. In addition, positioning holes 8.1 and positioning pin holes 8.2 may also be formed in the supporting frame, and the device is positioned and fastened in a laser projection system through positioning pins and bolts.

### Embodiment 3

As shown in FIG. 10, an in-plane two-dimensional translational optical actuator in this embodiment includes a fixed plate 1, a drive coil supporting seat 2, elastic assemblies 3 composed of a plurality of elastic elements, drive coils 4, a magnet supporting seat 5, magnets 6 and a translational plate 7. The magnet supporting seat 5 is connected with the fixed plate 1 to provide supporting for the magnets 6, and the magnets 6 are placed on corresponding supporting structures on the magnet supporting seat 5. The drive coil supporting seat 2 is connected with the translational plate 7 to provide supporting for the drive coils 4, and the drive coils 4 are placed on corresponding supporting structures on the drive coil supporting seat 2 and disposed in alignment with the magnets 6. Upper end parts of the elastic elements of the elastic assemblies 3 are connected with the fixed plate 1, and lower end parts are connected with the translational plate 7. Outlet terminals of the drive coils 4 are welded to corresponding pads of the translational plate 7, and a drive electric signal is introduced into an electric signaling pathway of the fixed plate 1 by the translational plate 7 via the elastic assemblies 3. The in-plane two-dimensional translational actuator has the operation principle that: drive signals are applied to two drive coils 4.1 and 4.3 on opposite sides, and pushing and pulling forces consistent in direction formed between the drive coils and the corresponding magnets 6 push the drive coil supporting seat 2 to drive the translational plate 7 to translate in a direction Y. Drive signals are applied to two drive coils 4.2 and 4.4 on opposite sides, and pushing and pulling forces consistent in direction formed between the drive coils and the corresponding magnets 6 push the drive coil supporting seat 2 to drive the translational plate 7 to translate in a direction X. Therefore, the translational plate 7 is driven to drive an optical element to translate in the two perpendicular directions X and Y. By adjusting the quantity and positions of the elastic elements of the elastic assemblies 3, a resonance frequency and a translation direction of the actuator are adjusted.

What is claimed is:

1. An in-plane two-dimensional translational optical actuator, comprising a fixed plate (1), a translational plate (7), i elastic assemblies (3) located between the fixed plate (1) and the translational plate (7) and with two ends connected to the fixed plate (1) and the translational plate (7) respectively, and j electromagnetic drive assemblies fixed between the fixed plate (1) and the translational plate (7), wherein i and j are both integers greater than or equal to 2; wherein
the fixed plate (1) is provided with a light transmission region;
the translational plate (7) is provided with a second light hole (7.2) used to place an optical element;
positions and sizes of the light transmission region and the second light hole (7.2) need to ensure that a light beam is able to enter the optical element placed in the second light hole (7.2);
each elastic assembly (3) is composed of elastic elements of the same or different quantities, and at least one elastic assembly (3) in the i elastic assemblies (3) has two or more elastic elements; and
the j electromagnetic drive assemblies are disposed in two different directions, and used to drive the translational plate (7) to move relative to the fixed plate (1) within a plane where the translational plate (7) is located in two different directions, so as to achieve two-dimensional translation of the translational plate (7).

2. The in-plane two-dimensional translational optical actuator according to claim 1, wherein: each electromagnetic drive assembly comprises a drive coil (4) and a magnet (6) disposed at a drive end of the drive coil (4); and
the drive coils (4) are arranged on the fixed plate (1) and the magnets (6) are arranged on the translational plate (7); or, the drive coils (4) are arranged on the translational plate (7) and the magnets (6) are arranged on the fixed plate (1).

3. The in-plane two-dimensional translational optical actuator according to claim 2, wherein: each electromagnetic drive assembly comprises at least two magnets (6) disposed at two drive ends of the drive coil (4) respectively, and the two magnets (6) have opposite polarities and have centers located on an axial central line of the drive coil (4).

4. The in-plane two-dimensional translational optical actuator according to claim 3, wherein: the elastic elements are made of conductive materials and used to provide follow-up components located on the translational plate (7) with an electric signaling pathway for transmission to the fixed plate (1).

5. The in-plane two-dimensional translational optical actuator according to claim 4, wherein: the elastic assemblies (3) have the same quantity of elastic elements, and the i elastic assemblies (3) are symmetrical about a central axis of the fixed plate (1), or, the elastic assemblies (3) have the different quantities of elastic elements, or the i elastic assemblies (3) form an asymmetric structure.

6. The in-plane two-dimensional translational optical actuator according to claim 1, wherein: j=4, and every two electromagnetic drive assemblies form a set of drive units, two sets of drive units in total; and two electromagnetic drive assemblies in the same set of drive units are used to drive the translational plate (7) to move relative to the fixed plate (1) within the plane where the translational plate (7) is located in the same direction.

7. The in-plane two-dimensional translational optical actuator according to claim 6, further comprising a drive coil supporting seat (2) and a magnet supporting seat (5), wherein the drive coils (4) are fixed on the drive coil supporting seat (2), and the magnets (6) are fixed on the magnet supporting seat (5);
the drive coil supporting seat (2) is fixed on the fixed plate (1), and the magnet supporting seat (5) is fixed on the translational plate (7); or
the drive coil supporting seat (2) is fixed on the translational plate (7), and the magnet supporting seat (5) is fixed on the fixed plate (1).

8. The in-plane two-dimensional translational optical actuator according to claim 7, wherein: the drive coil supporting seat (2) comprises two supporting arms arranged in parallel, one end of each supporting arm is fixed on the fixed plate (1) or the translational plate (7), the other end of each supporting arm is provided with a clamping groove, and the two drive ends of each drive coil (4) are clamped in the clamping grooves to be fixed; and the axial central lines of the drive coils (4) of the two electromagnetic drive assemblies in one set of drive units are parallel to a direction X, and the axial central lines of the drive coils (4) of the two electromagnetic drive assemblies in another set of drive units are parallel to a direction Y.

9. The in-plane two-dimensional translational optical actuator according to claim 7, wherein: the drive coil supporting seat (2) comprises a supporting frame and a coil positioning structure fixed on the supporting frame, one end of each coil positioning structure is provided with a clamping groove, and the two ends of each drive coil (4) are clamped in the clamping grooves to be fixed; and the axial central lines of the drive coils (4) of the two electromagnetic drive assemblies in one set of drive units are parallel to a direction X, and the axial central lines of the drive coils (4) of the two electromagnetic drive assemblies in another set of drive units are parallel to a direction Y.

10. The in-plane two-dimensional translational optical actuator according to claim 9, wherein: the light transmission region of the fixed plate (1) is provided with a first light hole (1.2); and the fixed plate (1) is a PCB, and an outlet terminal of each drive coil (4) is welded to a corresponding pad of the fixed plate (1).

11. The in-plane two-dimensional translational optical actuator according to claim 10, wherein: the translational plate (7) is a PCB, and the translational plate (7) is hollowed-out except a functional region.

12. The in-plane two-dimensional translational optical actuator according to claim 11, wherein: the fixed plate (1) and the translational plate (7) are each a rectangular PCB and are parallel to each other, and a center of the fixed plate (1) and a center of the translational plate (7) are located on a same straight line;
the light transmission region of the fixed plate (1) is located at the center of the fixed plate (1), and the second light hole (7.2) of the translational plate (7) is located at the center of the translational plate (7);
i=4, the 4 elastic assemblies (3) are parallel to each other, one ends of the elastic assemblies are fixed to four corners of the fixed plate (1) respectively, and the other ends are fixed to four corners of the translational plate (7) respectively; and
the electromagnetic drive assemblies are located between every two adjacent elastic assemblies (3).

13. The in-plane two-dimensional translational optical actuator according to claim 12, wherein: each drive coil (4) is formed by winding a wire on a magnetic core, and end faces of the magnetic core are round, rectangular or square; and the magnets (6) opposite to the two end faces of the magnetic core in the corresponding electromagnetic drive assembly have rectangular sections.
